(19) United States
(12) Patent Application Publication
(10) Pub. No.: US 2026/0161565 A1
(43) Pub. Date: Jun. 11, 2026

(54) RECOVERY PATH CACHE

(71) Applicant: Intel Corporation, Santa Clara, CA (US)

(72) Inventors: Zeshan A. Chishti, Beaverton, OR (US); Jeffrey J. Cook, Portland, OR (US); Ammon J. Christiansen, Warren, OR (US); Ariel Sabba, Lavon (IL); Muhammad Faisal Azeem, Hillsboro, OR (US); Xiang Zou, Portland, OR (US); Rangeen Basu Roy Chowdhury, Santa Clara, CA (US); Polychronis Xekalakis, San Jose, CA (US)

(73) Assignee: Intel Corporation, Santa Clara, CA (US)

(21) Appl. No.: 18/972,585

(22) Filed: Dec. 6, 2024

(51) Int. Cl. G06F 12/0862

(52) U.S. Cl. CPC G06F 12/0862

(57) ABSTRACT

Methods and apparatus relating to a Recovery Path Cache (RPC) are described. In an embodiment, an RPC stores information corresponding to a mispredicted branch. Logic circuitry of a processor searches the RPC in response to a subsequent misprediction of the branch and supplies the stored information, corresponding to the mispredicted branch, to a next stage of the processor. Other embodiments are also disclosed and claimed.

### FIELD OF THE INVENTION

The present disclosure generally relates to the field of processors. More particularly, some embodiments relate to a recovery path cache.

### BACKGROUND OF THE INVENTION

To improve performance, some processors utilize speculative processing (also sometimes referred to as Out-Of-Order (OOO) processing), which attempts to predict the future course of an executing program to speed its execution, for example, by employing parallelism. The predictions may or may not end up being correct. When they are correct, a program may execute in less time than when non-speculative processing is employed. When a prediction is incorrect, however, the processor has to recover its state to a point prior to the misprediction which can create inefficiencies.

Moreover, in modern superscalar OOO processors, performance can be significantly affected by branch mispredictions, which result in a large amount of work being flushed from a processor's pipeline and in instructions from the correct path being delayed from entering the processor pipeline. As instruction windows of processors expand, the penalties from control flow mis-speculation continue to increase.

Hence, there is a general need to improve prediction latency and reduce mispredictions.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates processor pipeline stages for an example Front End (FE) pipeline, which may be utilized in at least one embodiment.

FIG. 2 illustrates a block diagram of a two-way associative Recovery Path Cache (RPC), according to an embodiment.

FIG. 3 illustrates an RPC pipeline for the raw instruction bytes-based RPC, according to an embodiment.

FIG. 4 illustrates an RPC pipeline for the decoded uop RPC, according to an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, there is a general need to improve prediction latency and reduce mispredictions. Moreover, as modern Central Processing Unit (CPU) processor cores continue to move towards deeper pipelines and more aggressive speculative execution, branch misprediction recovery latency is becoming a key limiter to processor performance scaling. On a branch misprediction, all the instructions that have been fetched after the mispredicted branch are flushed from the processor pipeline, and the processor frontend recovers by redirecting instruction fetch to the correct path after the branch. Consequently, the latency of the entire frontend pipeline (branch prediction, instruction fetch, and instruction decode) becomes fully exposed after a branch misprediction.

To this end, some embodiments provide a recovery path cache. In an embodiment, a specialized instruction caching structure (called Recovery Path Cache (RPC)) helps to effectively shorten the front-end pipeline length after a branch misprediction. One embodiment allows caching the instruction sequences along the “recovery path” of a frequently mispredicted branch in a (e.g., small) purpose-built cache (called the “RPC”). On a subsequent misprediction, if the instructions from the recovery path are found in the RPC, then the RPC can deliver recovery path instruction sequence or micro operations (or “uops”) to the processor backend in a more expeditious manner.

By contrast, some solutions for reducing branch misprediction latency may involve fetching both the taken and not-taken paths of a predicted branch. These techniques are generally referred to as Multi-Path Execution. Rather than predicting the outcome of a conditional branch and fetching instructions from the predicted target, multipath execution fetches and executes instructions from both paths after the branch. Such multi-path execution obviates the need for misprediction recovery. While these schemes can mitigate branch mispredictions, they introduce substantial additional complexity in tracking instructions from several different execution paths in different pipeline stages. Furthermore, these schemes tend to waste processor resources and incur performance overheads in instances where a branch is predicted reliably by the branch predictor.

Another potential solution, which does not explicitly target branch misprediction latency, but can reduce frontend latency in general, is a micro operation cache (or uop cache). Uop caches are common in processors which use variable length Instruction Set Architectures (ISAs) (e.g., x86 Architecture provided by Intel® Corporation of Santa Clara, California), such as the Decoded Stream Buffer (DSB) in Intel's P-core processors and uop cache in AMD® processors. One main purpose of uop caches is to reduce the instruction decode energy by caching the decoded uops for frequently fetched instruction sequences. Uop caches do not target branch misprediction recovery paths specifically and instead attempt to cache all frequently fetched prediction blocks. In contrast, since RPC focuses only on caching instructions from recovery paths and is not meant to service the steady state instruction fetch, one can afford to make the RPC much smaller than the uop cache, thereby reducing RPC access latency and providing fast misprediction recovery, while utilizing less semiconductor real-estate and potentially consuming less power.

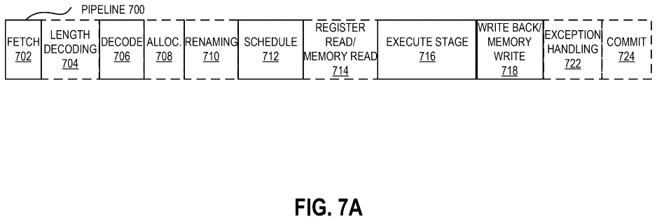

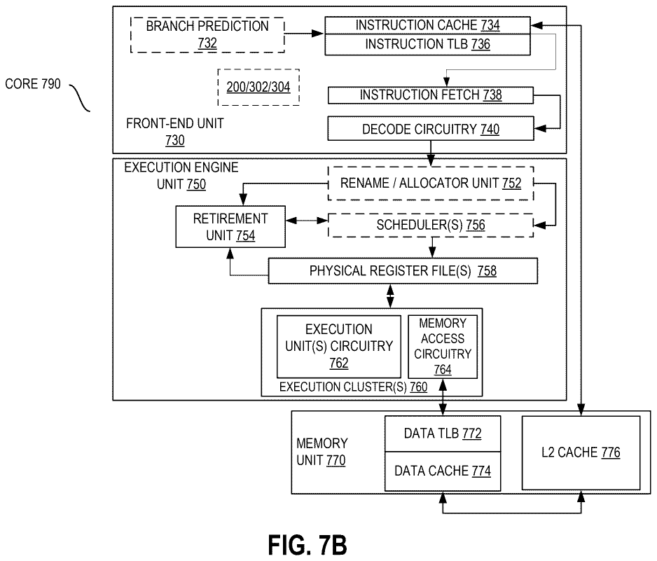

Moreover, in at least one embodiment, the instruction sequences along the “paths” that follow frequently mispredicted branches are stored/cached in a new caching structure (called Recovery Path Cache or “RPC”). RPC is filled with the sequence of instructions fetched and/or decoded after a misprediction. On a subsequent misprediction, if the program follows the same control flow as it did at the time of RPC fill, then the cached instructions can be fetched from the RPC and supplied to the processor backend (e.g., execution engine unit 750 of FIG. 7B) in an expeditious manner.

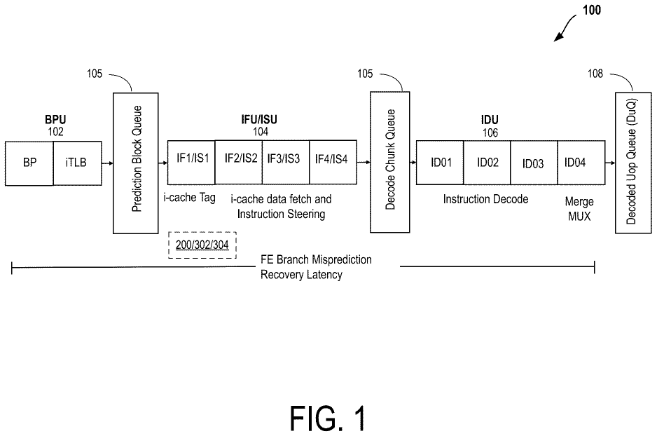

FIG. 1 illustrates processor pipeline stages for an example Front End (FE) pipeline 100, which may be utilized in at least one embodiment. In an embodiment, FIG. 1 shows the different stages in the frontend of an example x86 processor pipeline. In one embodiment, one or more components of FIG. 1 are also shown and discussed with reference to FIG. 7B.

Referring to FIG. 1, Branch Prediction Unit (BPU) 102 provides predictions and targets for both conditional and unconditional branches. These predictions are specified as prediction blocks. A prediction block comprises the sequential range of addresses from a starting address to the address of the last byte of a predicted taken branch. The next prediction block starts from the target address of the taken branch. The maximum length of a prediction block is specified as a multiple of cache line size, for example, two 64B cachelines or 128B. If no branch within the maximum length is predicted as taken, then the prediction block terminates at the boundary of the last line, for example the last byte in the second cacheline in a 128B prediction block.

The prediction blocks produced by the BPU 102 are fed into the Instruction Fetch Unit (IFU) 104 via a Prediction Block Queue 105. The IFU accesses the instruction cache tags and data to fetch the raw instruction bytes for the instructions that are contained within a prediction block. Since a prediction block may span across multiple cachelines, one prediction block may need multiple instruction cache accesses. In parallel, the Instruction Steering Unit (ISU) determines how the instruction bytes can be distributed to the different instruction decoders. In an embodiment, the ISU may include multiple decode clusters, e.g., to deal with CISC instructions. This steering information is necessary in processors with variable-length instructions, since the instruction boundaries are not implicitly obvious. The IFU and ISU generate decode chunks (e.g., stored in a decode chunk queue 105), which contain the necessary instructions bytes and boundary information for individual decoders.

The instruction decoders in the Instruction Decod Unit (IDU) 106 generate individual uops for every instruction. The IDUs in high performance processors are often implemented in a clustered fashion. The steering information sent by the ISU determines how the instruction bytes are distributed across the individual decoders within each cluster. Each decoder writes decoded uops to the Decoded Uop Queue (DuQ) 108, from where they can be consumed by the Out-Of-Order (OOO) execution engine.

On a branch misprediction, all the instructions that follow the mispredicted branch are flushed from the processor pipeline and the frontend is redirected to the correct target of the mispredicted branch. The sequence of instructions that follow the correct branch target is known as the recovery path. The branch predictor initiates recovery by making predictions along the recovery path and writing the resulting prediction blocks to the prediction block queue. For the purpose some embodiments, the branch misprediction recovery latency is defined as the time taken by the FE pipeline after a misprediction to deliver the first recovery path uop to the OOO. For the FE pipeline shown in FIG. 1, the misprediction recovery latency is equal to the FE pipeline length from the BPU 102 to the DuQ 108 (sometimes also referred to herein as an Instruction Decode Queue (IDQ)).

Accordingly, some embodiments reduce the misprediction recovery latency. As shown in FIG. 1, reducing the length of the recovery pipeline would require bypassing the pipeline stages from the BPU, IFU, IDU, or a combination thereof. To that end, RPC may provide an alternative pipeline that can shorten the pipeline length after a branch misprediction. To achieve this goal, the RPC caches the instruction contents of prediction blocks that comprise the recovery paths of frequently mispredicted branches.

### RPC Components

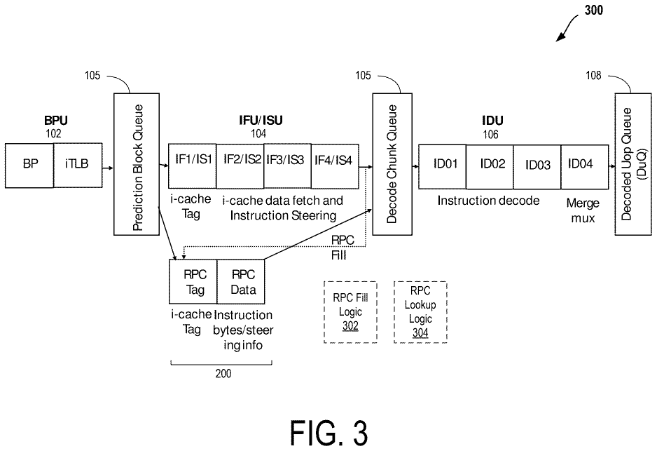

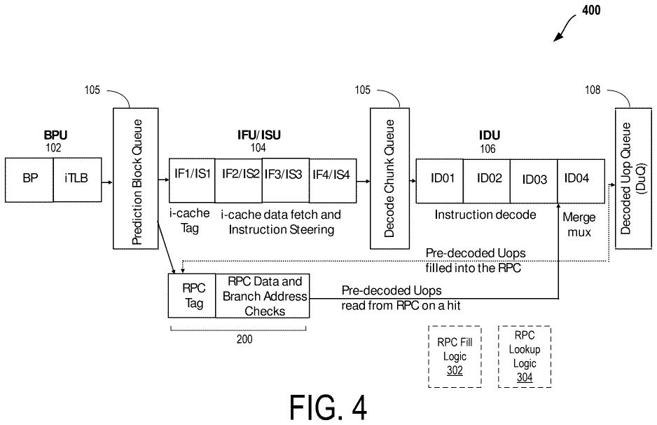

As will be further discussed with reference to FIGS. 3 and 4, in some embodiments, the RPC utilizes at least two components. First, a fill logic 302 which identifies frequently mispredicted branches and fills the instruction contents from the recovery paths of these branches into the RPC. Second, a lookup logic 304, which searches the RPC after branch mispredictions and then (in case of hits) fetches the instruction contents from the RPC to deliver them to the IDU and/or a backend of the processor (e.g., the execution engine unit 750 of FIG. 7B). In one embodiment, since the RPC is tailormade to cache only a small number of prediction blocks, RPC may be designed to be much smaller and therefore faster than a traditional instruction cache. This approach may allow an RPC implementation to provide about 2 to 3 cycles latency savings compared to a non-RPC path.

### Example: High-Level Workings of RPC

Consider a branch “A” which has been predicted incorrectly by the branch predictor as “not taken.” After the branch is executed, the branch execution unit determines that the correct outcome of the branch is “taken.” At this point, the OOO engine sends a misprediction recovery signal along with the correct branch target information to the FE. The BPU starts recovery by predicting the subsequent prediction blocks following the correct target. Let's denote the next three prediction blocks predicted by the CPU to be B, C, and D respectively. Following the branch misprediction, the RPC fill logic 302 may decide (based on a fill criterion described below under RPC Fill section) to fill the instruction contents for B, C, and D into the RPC. At a later point during the program execution, assume that “A” is mispredicted again as “not taken” and the next three prediction blocks predicted by the branch predictor are B, C, and E, respectively. Since the first two of these three prediction blocks (B, C) have been filled into the RPC previously, they are likely to hit in the RPC, enabling faster recovery.

### RPC Organization

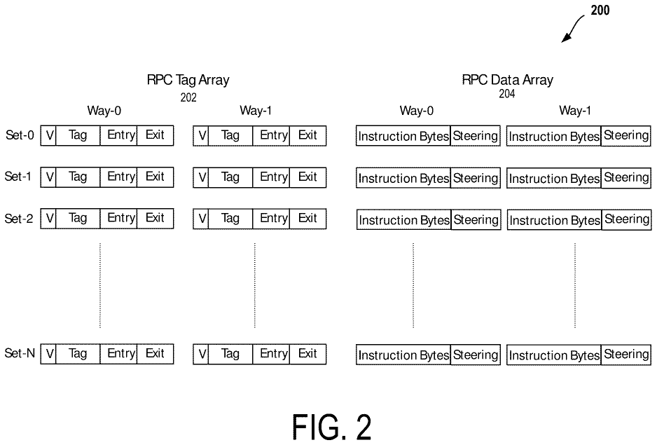

FIG. 2 illustrates a block diagram of a two-way associative Recovery Path Cache (RPC) 200, according to an embodiment. As shown in FIG. 2, RPC may be organized as a set-associative cache, where each RPC entry comprises the instruction contents corresponding to one prediction block. Moreover, the RPC consists of a tag array 202 and a data array 204. The tag array contains the address of the prediction block that is being cached by the RPC entry, whereas the instruction contents are stored in the data array.

### RPC Tag Array

Referring to FIG. 2, the RPC tag array 202 is looked up with the prediction block information produced by the branch predictor. This information may include the following: (i) cache-aligned starting address which is used to generate the set index and tag for the tag array lookup, (ii) the entry offset of the prediction block relative to the cache-aligned starting address, and (iii) the exit offset of the prediction block relative to the cache-aligned starting address. If the tag, entry point offset, and exit point offset for one of the RPC entries in the given set matches the information included in the prediction block, then this is considered as an RPC hit. The data array then provides the instruction contents and the other relevant information, as described in the next section.

### Instruction Contents in RPC Data Array

Regarding the exact instruction contents that need to be saved in an RPC cacheline, there are two main options in various embodiments:

### Option 1: Raw Instruction Bytes Based RPC

In one embodiment (such as shown in FIG. 2), the RPC entry stores the raw instruction bytes for the addresses that comprise the prediction block. These raw bytes are identical to the bytes stored in the instruction cache for the same sequence of addresses. In addition, each RPC entry also stores the steering information for the cachelines that comprise the prediction block. Together with the raw instruction bytes, these steering controls allow for routing the instruction bytes from the RPC directly to the appropriate decoder, bypassing the IFU and ISU pipelines.

FIG. 3 illustrates an RPC pipeline 300 for the raw instruction bytes-based RPC, according to an embodiment. In one embodiment, one or more components of FIG. 3 are also shown and discussed with reference to FIG. 7B.

The example pipeline operation for this design option 1 is shown in FIG. 3. The latency savings for the RPC path come from, (i) the lower access latency of RPC in comparison with the much larger instruction cache, and (ii) the readily available steering information in the RPC, which was filled at the RPC fill time and does not need to be generated by the ISU pipeline. Note that this design option reduces only IFU latency and does not hide any of the IDU latency on the recovery path. However, one advantage of using the regular IDU pipeline is that the recovery path instructions can leverage the full decode bandwidth of the IDU.

### Option-2: Decoded Uops Based RPC

In this option, the pre-decoded uops are directly stored in the RPC. These uops are produced by the decoder at the time of RPC fill and stored in the RPC entry. On an RPC hit, the pre-decoded uops can be sent directly from the RPC to the merge multiplexer (where the terms “multiplexer” and “mux” are interchangeable herein) that writes the uops to the DuQ 108. The pipeline latency savings for an example implementation of this option 2 are shown in FIG. 4.

More particularly, FIG. 4 illustrates an RPC pipeline 400 for the decoded uop RPC, according to an embodiment. In one embodiment, one or more components of FIG. 4 are also shown and discussed with reference to FIG. 7B.

As shown in FIG. 4, at least one advantage of this option 2 is that latency is reduced for both the IFU latency as well as a portion of the IDU latency. However, one drawback is that storing decoded uops introduces multiple additional restrictions and complexities: First, pre-decoded uops for an instruction take up much more space (approximately 5∴ to 10× higher) than the raw bytes per instruction. Since most prediction blocks do not take up the maximum prediction block length (average prediction block length being about 10 instructions), we may restrict the number of uops per RPC line to a smaller number (e.g., 10 or 12). Any prediction blocks that contain more uops than this threshold number may be restricted from being filled in the RPC. Second, since decoded uops take more space than raw instruction bytes, option 2 would require either a much larger bit storage than option 1 or it will need to be built with significantly fewer entries. Third, multiplexing between uops fetched from the RPC and uops decoded by the regular instruction decoders in the IDU, creates a routing problem, which makes it difficult to make the RPC path high bandwidth. For example, a uop-based RPC might be only about 10 to 12 uop wide, whereas the clustered decoder in a high-performance processor may be designed to have a throughput of about 24 uops per cycle.

Therefore, the choice between raw instruction bytes RPC and uop-based RPC may be based on a tradeoff between latency, complexity, and bandwidth. In at least one embodiment, a raw instruction byte RPC option 1 provides a better overall tradeoff.

### RPC Fill

The RPC fill logic 302 inserts new cachelines into the RPC after an RPC miss. The information needed to fill a new cacheline into the RPC is generated by the IFU and the IDU as the prediction blocks along the recovery path traverse through the FE pipeline. Raw instruction bytes and predecode bits come from the IFU. The instruction steering pipeline creates the steering control information. All the necessary information (prediction block addresses/boundaries, instruction bytes and steering controls/decoded uops) for new RPC cachelines becomes available after the instructions from the recovery path have been decoded.

### RPC Fill Filter

The RPC fill logic 302 needs to decide when to fill a new recovery path into the RPC. The simplest approach is to fill the RPC on every misprediction. The potential downside of this approach is that if the branch is never mispredicted again, then the RPC capacity is wasted. In fact, for branches with complex prediction patterns, branch predictors often need multiple mispredictions to be trained. Therefore, the always-fill approach can cause undesired RPC thrashing.

To solve this problem, a small filtering structure called RPC filter may be used. The RPC filter may prioritize RPC allocation based on how many times a branch is mispredicted. RPC filter may cache the addresses of the recently mispredicted branches along with a small counter (e.g., 2 or 3-bit wide). On a branch misprediction, if there is a hit in the RPC filter, then the counter is incremented. When the counter saturates, the RPC fill logic 302 decides to fill the recovery path for the branch into the RPC and evict the branch entry from the RPC filter.

### RPC Fill Length

Another decision that the RPC fill logic 302 may make is how many prediction blocks to fill into the RPC after a branch misprediction. Let us refer to this as the Recovery Path Fill Length (RPFL). Since the RPC path is faster than the non-RPC path, the switch from RPC to non-RPC path can cause FE pipeline bubbles, e.g., showing up as no uops being written to the IDQ. The RPFL may be chosen to be large enough such that when a recovery path filled into the RPC is replayed later a subsequent misprediction, the RPC can supply enough uops to keep the OOO engine busy, while switching from the RPC to the non-RPC path. However, if RPFL is chosen to be too high, then the RPC capacity would be wasted. In at least one embodiment, caching 4 to 8 prediction blocks on the fill path may yield good overall results.

### RPC Partial Hits and Appends

In some embodiments, if there is a partial RPC hit, a repair (prepend/append) takes place. Repair may be similar to fill but will end up overwriting an existing RPC entry rather than victimizing another entry.

Repair (prepend/append) cases may occur when the RPC is looked up and it fails to hit because:
(a) entry point of the prediction block is earlier than the previously fill entry point; and/or
(b) exit point of the prediction block is after the previous filled exit point.

For these repair operations, the steering controls may be regenerated to overwrite the RPC entry with the new steering controls.

### RPC Lookup

In one embodiment, RPC is looked up only after branch misprediction. After a misprediction, the first prediction block predicted by the BPU is used to look up the RPC tag array. If there is a miss in the RPC, then no further lookups will be carried out and the fill logic 302 will decide whether to fill the recovery path into the RPC (described in RPC Fill section). If there is a hit in the RPC, then the RPC data array supplies the instruction contents (raw bytes or pre-decoded uops as discussed under the RPC Organization section) to the OOO engine. For subsequent prediction blocks predicted by the BPU, the RPC may continue to be looked up as long as there are RPC hits. However, after the very first miss in the RPC, the RPC look up may be stopped and the process may switch to the non-RPC path for the subsequent prediction blocks. Thereafter, the RPC may only be looked up after the next branch misprediction. This is a significant contrast from the DSB, where the DSB is looked up for every prediction block and it is common to switch back and forth between the DSB and non-DSB paths during steady state operation.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

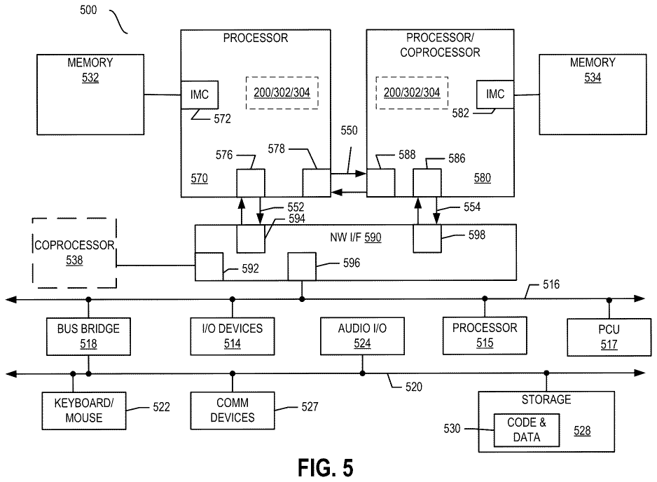

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors'local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 517, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage 'ISAB03 in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

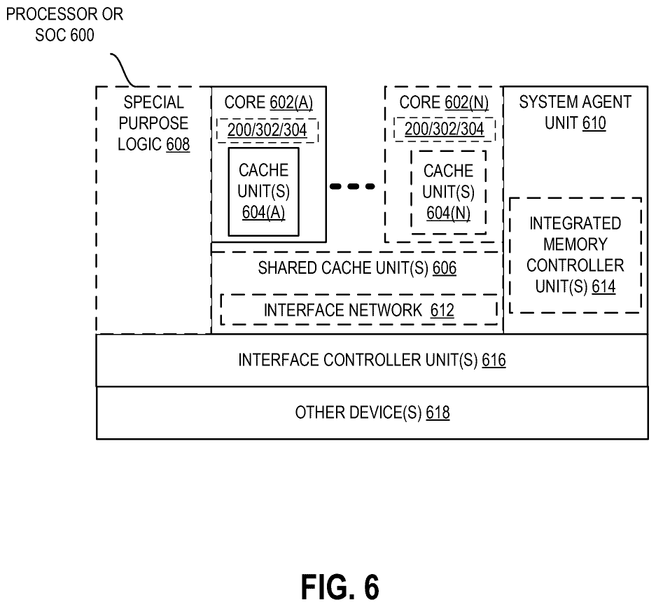

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures-in-Order and Out-of-Order Core Block Diagram

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIG. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

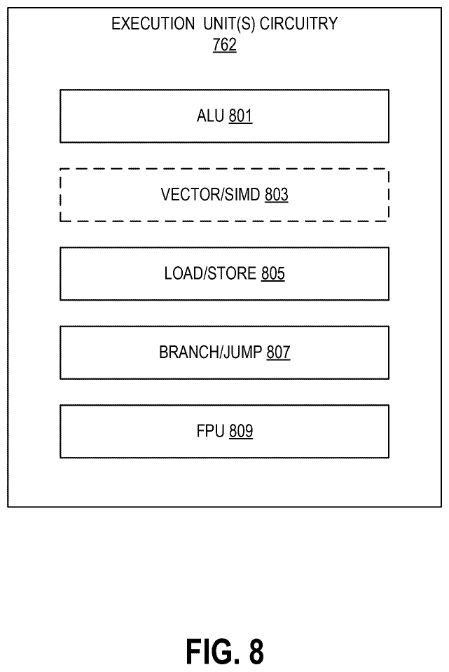

FIG. 8 illustrates examples of execution unit(s) circuitry, such as execution unit(s) circuitry 762 of FIG. 7(B). As illustrated, execution unit(s) circuity 762 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes a processor comprising: a Recovery Path Cache (RPC) to store information corresponding to a mispredicted branch; and logic circuitry to search the RPC in response to a subsequent misprediction of the branch and to supply the stored information, corresponding to the mispredicted branch, to a next stage of the processor. Example 2 includes the processor of example 1, wherein the next stage of the processor is one of an Instruction Decode Unit (IDU) or an execution engine unit. Example 3 includes the processor of example 1, comprising logic circuitry to identify one or more frequently mispredicted branches and to fill the RPC with the information corresponding to the one or more frequently mispredicted branches.

Example 4 includes the processor of example 1, comprising logic to fill the RPC with the information corresponding to the one or more frequently mispredicted branches on every misprediction. Example 5 includes the processor of example 1, comprising logic circuitry to fill the RPC with the information corresponding to the one or more frequently mispredicted branches based at least in part on a number of times a branch is mispredicted. Example 6 includes the processor of example 1, comprising logic circuitry to overwrite an existing entry in the RPC in response to a partial hit in the RPC. Example 7 includes the processor of example 1, wherein the stored information comprises a sequence of instructions along a path following the mispredicted branch.

Example 8 includes the processor of example 1, wherein the stored information comprises a plurality of fetched instructions or decoded instructions along a path following the mispredicted branch. Example 9 includes the processor of example 1, wherein the RPC includes a tag array and a data array. Example 10 includes the processor of example 9, wherein the tag array stores an address of a prediction block that is being cached in an entry of the RPC entry. Example 11 includes the processor of example 9, wherein the data array stores instruction contents of a prediction block that is being cached in an entry of the RPC entry. Example 12 includes the processor of example 9, wherein the data array is to store raw instruction bytes.

Example 13 includes the processor of example 9, wherein the data array is to store one or more micro operations. Example 14 includes the processor of example 1, Wherein the branch is frequently mispredicted. Example 15 includes the processor of example 1, wherein the RPC is to be organized as a set-associative cache, wherein each RPC entry comprises the instruction contents corresponding to one prediction block. Example 16 includes the processor of example 1, wherein a front end of the processor comprises the RPC. Example 17 includes the processor of example 1, wherein the processor comprises one or more processor cores, wherein each of the one or more processor cores comprises the RPC and the logic circuitry.

Example 18 includes one or more non-transitory computer-readable media comprising one or more instructions that when executed on a processor configure the processor to perform one or more operations to cause: a Recovery Path Cache (RPC) to store information corresponding to a mispredicted branch; and logic circuitry to search the RPC in response to a subsequent misprediction of the branch and to supply the stored information, corresponding to the mispredicted branch, to a next stage of the processor.

Example 19 includes the one or more non-transitory computer-readable media of example 18, further comprising one or more instructions that when executed on the processor configure the processor to perform one or more operations to cause logic circuitry to identify one or more frequently mispredicted branches and to fill the RPC with the information corresponding to the one or more frequently mispredicted branches. Example 20 includes the one or more non-transitory computer-readable media of example 18, further comprising one or more instructions that when executed on the processor configure the processor to perform one or more operations to cause logic circuitry to fill the RPC with the information corresponding to the one or more frequently mispredicted branches on every misprediction.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a Recovery Path Cache (RPC) to store information corresponding to a mispredicted branch; and
logic circuitry to search the RPC in response to a subsequent misprediction of the branch and to supply the stored information, corresponding to the mispredicted branch, to a next stage of the processor.

2. The processor of claim 1, wherein the next stage of the processor is one of an Instruction Decode Unit (IDU) or an execution engine unit.

3. The processor of claim 1, comprising logic circuitry to identify one or more frequently mispredicted branches and to fill the RPC with the information corresponding to the one or more frequently mispredicted branches.

4. The processor of claim 1, comprising logic to fill the RPC with the information corresponding to the one or more frequently mispredicted branches on every misprediction.

5. The processor of claim 1, comprising logic circuitry to fill the RPC with the information corresponding to the one or more frequently mispredicted branches based at least in part on a number of times a branch is mispredicted.

6. The processor of claim 1, comprising logic circuitry to overwrite an existing entry in the RPC in response to a partial hit in the RPC.

7. The processor of claim 1, wherein the stored information comprises a sequence of instructions along a path following the mispredicted branch.

8. The processor of claim 1, wherein the stored information comprises a plurality of fetched instructions or decoded instructions along a path following the mispredicted branch.

9. The processor of claim 1, wherein the RPC includes a tag array and a data array.

10. The processor of claim 9, wherein the tag array stores an address of a prediction block that is being cached in an entry of the RPC entry.

11. The processor of claim 9, wherein the data array stores instruction contents of a prediction block that is being cached in an entry of the RPC entry.

12. The processor of claim 9, wherein the data array is to store raw instruction bytes.

13. The processor of claim 9, wherein the data array is to store one or more micro operations.

14. The processor of claim 1, Wherein the branch is frequently mispredicted.

15. The processor of claim 1, wherein the RPC is to be organized as a set-associative cache, wherein each RPC entry comprises the instruction contents corresponding to one prediction block.

16. The processor of claim 1, wherein a front end of the processor comprises the RPC.

17. The processor of claim 1, wherein the processor comprises one or more processor cores, wherein each of the one or more processor cores comprises the RPC and the logic circuitry.

18. One or more non-transitory computer-readable media comprising one or more instructions that when executed on a processor configure the processor to perform one or more operations to cause:
a Recovery Path Cache (RPC) to store information corresponding to a mispredicted branch; and
logic circuitry to search the RPC in response to a subsequent misprediction of the branch and to supply the stored information, corresponding to the mispredicted branch, to a next stage of the processor.

19. The one or more non-transitory computer-readable media of claim 18, further comprising one or more instructions that when executed on the processor configure the processor to perform one or more operations to cause logic circuitry to identify one or more frequently mispredicted branches and to fill the RPC with the information corresponding to the one or more frequently mispredicted branches.

20. The one or more non-transitory computer-readable media of claim 18, further comprising one or more instructions that when executed on the processor configure the processor to perform one or more operations to cause logic circuitry to fill the RPC with the information corresponding to the one or more frequently mispredicted branches on every misprediction.
